(19) United States
(12) Patent Application Publication
(10) Pub. No.: US 2006/0036984 A1
(43) Pub. Date: Feb. 16, 2006

(54) Device and method for extracting parasitic capacitance of semiconductor circuit

(75) Inventor: Kazunobu Mukaihira, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/032,187

(22) Filed: Jan. 11, 2005

(30) Foreign Application Priority Data
Aug. 13, 2004 (JP) 2004-235702

(51) Int. Cl. G06F 17/50

(52) U.S. Cl. 716/5

(57) ABSTRACT

A device for extracting parasitic capacitance including the influence of a dummy metal pattern inserted between the circuit wires of a semiconductor device comprises a permittivity correction unit for correcting the permittivity of a dielectric existing between the circuit wires in accordance with the insertion of the dummy metal and a parasitic capacitance extraction unit for extracting parasitic capacitance between the circuit wires, based on the corrected permittivity and the layout of a circuit.

### CROSS REFERENCE TO RELATED APPLICATIONS

This application is based upon and claims the benefit of priority from the prior Japanese Patent Application No. 2004-235702, filed in Aug. 13, 2004, the entire contents of which are incorporated herein by reference.

### BACKGROUND OF THE INVENTION

1. Field of the Invention

The present invention relates to the design method of semiconductor devices, more particularly to a parasitic capacitance extracting method for extracting parasitic capacitance which increases due to the influence of a dummy metal pattern inserted between the wires of a circuit in the manufacturing process of semiconductor devices.

2. Description of the Related Art

With the recent high-integration of semiconductor devices, finer wiring patterns have been formed. Such a highly integrated semiconductor device adopts a multi-wiring structure in which a plurality of wiring layers is provided on a substrate. In the manufacturing process of such a wiring layer with a multi-wiring structure, fine patterns cannot be formed if the degree of flatness of a substrate surface is low. Therefore, a flattening process is applied to the substrate surface by chemical/mechanical polishing (CMP) or the like.

However, if the difference in the degree of congestion of wires between wiring layers is large, it is difficult to flatten the substrate surface even by CMP. Therefore, the degree of wiring congestion is averaged by inserting a dummy metal in a wiring area with the low degree of wiring congestion to reduce the difference in the degree of wiring congestion.

However, such a dummy metal inserted in a wiring layer in an electrically floating state. Therefore, the fluctuation of this static capacitance parasitic on wiring must be estimated by some method and be fluctuated. However, since generally a lot of dummy metals are inserted in a complex shape, it is difficult to define a wiring shape in detail and to accurately analyze an electromagnetic field. Since ordinary layout data includes no dummy metal, it is also difficult to accurately estimate the fluctuation of static capacitance due to the insertion of a dummy metal.

FIG. 1 is a flowchart showing a process using a conventional resistor/capacitor (RC) extracting tool. In FIG. 1, firstly, in step S100, an input file for capacitance calculation is generated from process information 50. The contents of this input file are the definitions of the thickness of a wiring film, the thickness of a film between layers, the permittivity of an inter-layer film and the like. In step S101, capacitance calculation is conducted by electro-magnetic field analysis or the like, using the generated input file for capacitance calculation 51, to generate parasitic capacitance database 52. Then, in step S102, wiring RC are extracted using the contents of the parasitic capacitance database 52 and the contents of a layout database 53.

In the process using the conventional RC extraction tool shown in FIG. 1, all dummy metals must be defined as wiring even if analysis including a dummy metal is possible by electromagnetic field analysis software. In reality, the number of processes of defining all the dummy metals that exist in a layout becomes enormous. Since the number of wiring structures is enormous, the calculation time of this process becomes very enormous.

Prior arts on such insertion of a dummy metal pattern in a wiring layer and the analysis of its influence are described below.

Japanese Patent Application No. Hei 2-140934 discloses a semiconductor device capable of disposing a dummy pattern in such a way that space in an area between wires in the same layer can be a minimum pitch, uniquely determining unit wiring capacitance regardless of a wiring pattern and calculating a delay time.

Japanese Patent Application No. 2002-149739 discloses a technology for comparing the calculated degree of wiring congestion in a semiconductor circuit layout with the degree of wiring congestion obtained when dummy wiring is disposed in a wiring area, and extracting, for example, parasitic capacitance from a semiconductor circuit layout including a circuit layout with dummy wiring, anticipated in the case where the wiring area whose degree of wiring congestion is calculated is one in which dummy wiring can be disposed.

Japanese Patent Application No. 2004-38280 discloses a technology for calculating a capacitance value between wiring patterns in the case where a dummy pattern is inserted using both the rules of a dummy pattern and process information about a wiring structure, and designing a semiconductor device using the capacitance value.

However, any of these references, more particularly the Japanese Patent Application No. 2004-38280, does not disclose a method for fairly simply calculating the fluctuation of capacitance due to an influence given when a dummy metal is inserted, and accordingly, cannot solve a problem that it is difficult to define a wiring shape in detail and to analyze an electromagnetic field as described above.

### SUMMARY OF THE INVENTION

It is an object of the present invention to be able to calculate the fluctuation of static capacitance due to a dummy metal pattern inserted between wires by correcting the permittivity of a dielectric, and to easily extract the parasitic capacitance of a semiconductor circuit.

One aspect of the present invention is a device for extracting parasitic capacitance including the influence of a dummy metal pattern inserted between circuit wires. The device comprises a permittivity correction unit for correcting the permittivity of a dielectric existing between the relevant circuit wires in accordance with the insertion of the relevant dummy metal pattern, and a parasitic capacitance extraction unit for extracting parasitic capacitance between the relevant circuit wires.

Another aspect of the present invention is a method for extracting parasitic capacitance including the influence of a dummy metal pattern inserted between circuit wires. The method comprises calculating the correction value of the permittivity of a dielectric existing between the relevant circuit wires in accordance with the insertion of the relevant dummy metal pattern, and extracting parasitic capacitance between the relevant circuit wires, based on both the correction value of the relevant permittivity and the layout of a circuit.

According to the above-mentioned device or method, parasitic capacitance can be extracted using a dummy metal, by considering a dummy metal as a dielectric with infinite permittivity. As a result, there is no need to define each dummy metal as a structure at the time of electromagnetic field analysis. Therefore, when using the RC extraction tool, the generation time of input information and the analysis time of en electromagnetic field can be widely shortened, which greatly contributes to the improvement of the design efficiency of semiconductor circuits.

### BRIEF DESCRIPTION OF THE DRAWINGS

The present invention will be more apparent from the following detailed description when the accompanying drawings are referenced.

FIG. 1 is the flowchart of the conventional wiring RC extraction process.

FIG. 2 is a block diagram showing the basic configuration of the semiconductor circuit parasitic capacitance extraction device of the present invention.

FIG. 3 is a flowchart showing the process of the semiconductor circuit parasitic capacitance extraction device of the present invention.

FIG. 4 is a flowchart showing the detailed process of a dummy metal correction routine shown in FIG. 3.

FIG. 5 shows an example of a wiring metal and the disposition of a dummy metal.

FIG. 6 explains the permittivity correction method of the present invention.

FIG. 7 explains the insertion of a dielectric whose permittivity to an adjacent area of a wiring metal.

FIG. 8 shows the section A-A′ in FIG. 7.

FIG. 9 explains one example of permittivity correction in a multi-layer structure (No. 1).

FIG. 10 explains one example of permittivity correction in a multi-layer structure (No. 2).

FIG. 11 shows the hardware configuration of the semiconductor circuit parasitic capacitance extraction device of the present invention.

FIG. 12 shows examples of a computer-readable storage medium on which is recorded a control program.

### DESCRIPTION OF THE PREFERRED EMBODIMENTS

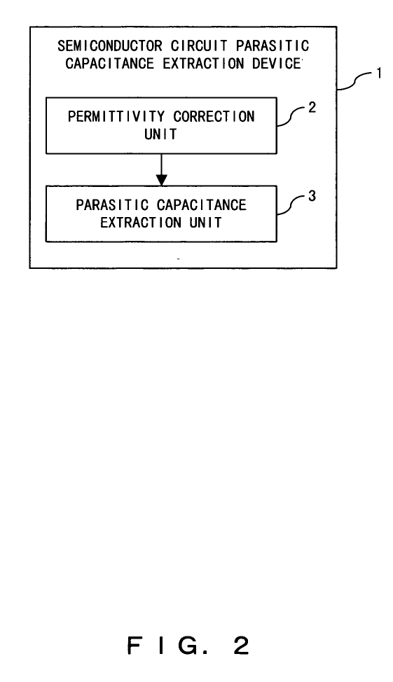

Firstly, the drawings are described. FIG. 2 is a block diagram showing the basic configuration of the semiconductor circuit parasitic capacitance extraction device of the present invention. FIG. 2 shows the basic configuration of a device for extracting parasitic capacitance generated by the influence of a dummy metal pattern inserted between circuit wires in the manufacturing process of semiconductor devices, such as an integrated circuit. A device 1 comprises a permittivity correction unit 2 and a parasitic capacitance extraction unit 3.

The permittivity correction unit 2 corrects the permittivity of a dielectric existing between the wires of a circuit in accordance with the insertion of a dummy metal pattern. The parasitic capacitance extraction unit 3 extracts parasitic capacitance between circuit wires, based on both the corrected permittivity and the layout of the circuit.

The permittivity correction unit 2 can also handle a dummy metal as a dielectric with infinite permittivity and correct permittivity. The permittivity correction unit 2 can also correct permittivity using the surface density in an area between wires of a dummy metal inserted between wires.

The parasitic capacitance extraction unit 3 can extract parasitic capacitance between circuit wires by applying permittivity before correction to a dielectric area adjacent to the circuit wires within a distance corresponding to design minimum space between the circuit wires and a dummy metal pattern and applying permittivity after correction to dielectric areas other than the adjacent area, according to the dummy pattern generation rules.

The present invention also includes a method used by the device, that is, a method for correcting the permittivity of a dielectric existing between circuit wires, in accordance with the insertion of a dummy metal pattern, and extracting parasitic capacitance between circuit wires, based on both the corrected permittivity and a circuit layout. The present invention also includes a computer-readable storage medium on which is recorded a program for enabling a computer to execute the method.

In the permittivity correction value calculation of the above-mentioned parasitic capacitance extraction method, a dummy metal can also be handled as a dielectric with infinite permittivity. This fact also applies to the above-mentioned program.

Furthermore, in the permittivity correction value calculation of the above-mentioned parasitic capacitance extraction method, permittivity can also be corrected using the surface density in an area between wires of a dummy metal inserted between wires. Alternatively, in the extraction of parasitic capacitance, circuit parasitic capacitance can be extracted by applying permittivity before correction to a dielectric area adjacent to the circuit wires within a distance corresponding to design minimum space between the circuit wiring and a dummy metal pattern, and applying permittivity after correction to dielectric areas other than the adjacent area, according to the dummy pattern generation rules.

Since the device 1 of the present invention has such a configuration, parasitic capacitance can be extracted using a dummy metal by considering a dummy metal as a dielectric with infinite permittivity. As a result, there is no need to define each dummy metal as a structure at the time of electro-magnetic field analysis, and accordingly, when using the RC extraction tool, the generation time of input information and the analysis time of en electro-magnetic field can be widely shortened, which greatly contributes to the improvement of the design efficiency of semiconductor circuits.

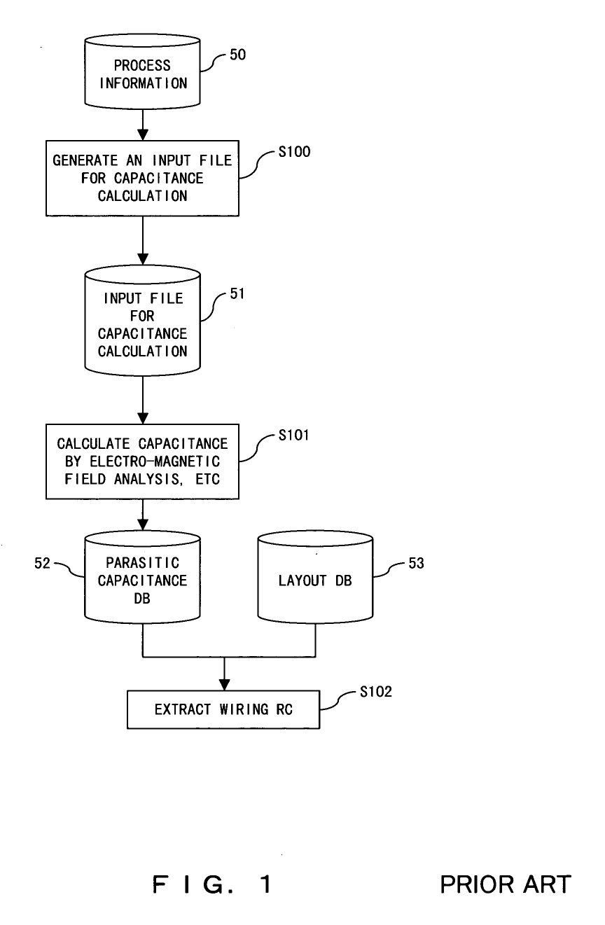

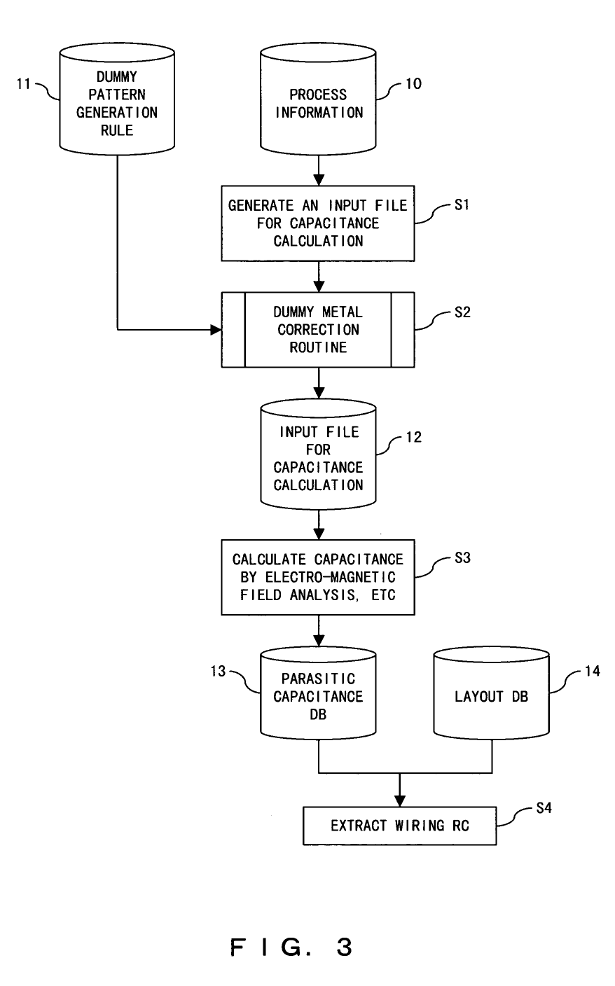

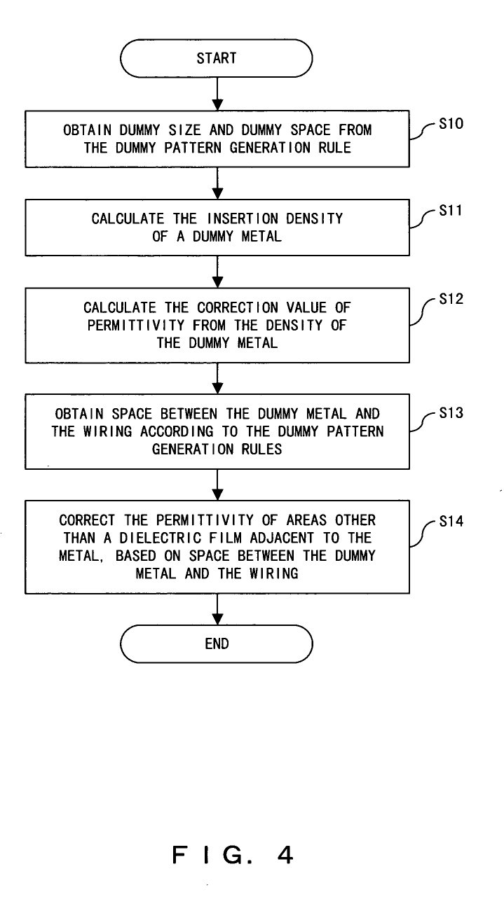

FIG. 3 is a flowchart showing the process of the semiconductor circuit parasitic capacitance extraction device of the present invention. In FIG. 3, as in the conventional case shown in FIG. 1, firstly, in step S1, an input file for static capacitance calculation is generated from process information. In step S2, the process of a dummy metal correction routine is performed according to a dummy pattern generation rule 11. The process of this routine is described later with reference to FIG. 4.

The process result of the dummy metal correction routine is reflected in an input file for capacitance calculation 12. In step S3, capacitance is calculated by electromagnetic field analysis, using the contents of the file, and the result is stored in a parasitic capacitance database 13. Then, in step S4, wiring RC are extracted using the result and the contents of a layout database 14.

FIG. 4 is a flowchart showing the detailed process of a dummy metal correction routine shown in step S2 of FIG. 3.

When the process is started in FIG. 4, firstly, in step S10, the size of a dummy metal and its space is obtained as the contents of the dummy pattern generation rule 11. Then, in step S11, the insertion density of a dummy metal, that is, surface density as a ratio of the area of a dummy metal pattern to the entire area between wires is calculated. Then, in step S12, the correction value of permittivity is calculated using the surface density. The calculation of this correction value is described later.

Then, in step S13, space between a dummy metal and wiring is obtained. Since in an area adjacent to the wiring, a dummy metal is not inserted in specific minimum space range, in the minimum space range, the process is performed using the essential permittivity of a dielectric without correcting the permittivity. Then, in step S14, permittivity is corrected in areas other than a dielectric film adjacent to the wiring metal within the minimum space (that is, adjacent area), and the process terminates. In other words, in the minimum space area adjacent to the wiring metal, permittivity is not corrected, and its essential permittivity is used.

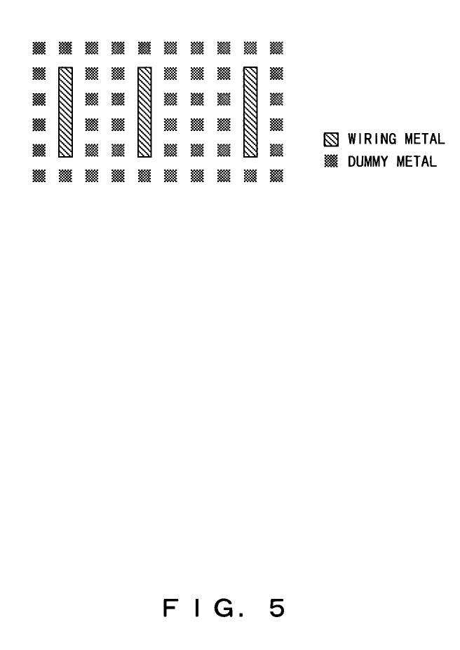

FIG. 5 shows an example of the insertion of a dummy metal in one wiring layer. For convenience' sake, dummy metals in the shape of a square are distributed and disposed around a linear wiring metal. Although in an actual semiconductor circuit, the patterns of a wiring metal and a dummy metal are not so simple, in this preferred embodiment, fairly simple patterns are used for convenience' sake.

In this preferred embodiment, the fluctuation of wiring parasitic capacitance due to a dummy metal inserted in the manufacturing process of semiconductors is estimated by correcting permittivity using the density of a surface in which a dummy metal is inserted.

A dummy metal flattens a surface in the CMP process by reducing the density difference of wiring. As shown in FIG. 5, in most cases, a lot of dummy metals in an electrically floating state are inserted between wires. Since a dummy metal in a floating state has an equal potential surface, it can be considered that electrical wiring space is narrow. Accordingly, wiring capacitance increases. In this preferred embodiment, permittivity is corrected by considering a dummy metal in a floating state as a dielectric with very high permittivity, that is, infinite permittivity.

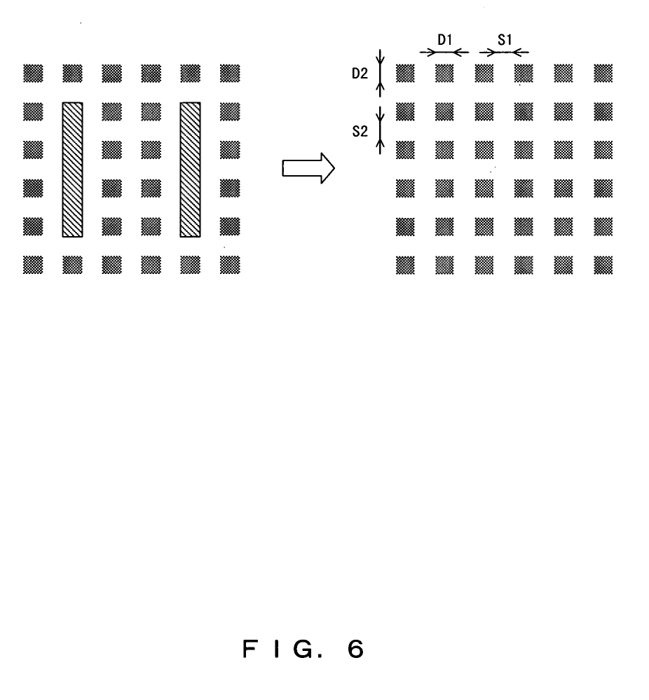

FIG. 6 explains the calculation method of the surface density of a dummy metal. As described in FIG. 5, in reality a dummy metal is inserted around a wiring metal, and a plane surface as shown on the left side is obtained. However, in this preferred embodiment, the density of a dummy metal inserted in a layout plane surface is calculated for each wiring layer using the width, space and the like of a dummy metal defined by the dummy pattern generation rule 11 described in FIG. 3.

In this case, essentially, the surface density of a dummy metal in an area between wiring metals must be calculated. However, in an actual layout, since there are a lot of wiring patterns on the layout, it is difficult to calculate the surface density of each dummy metal between wiring metals in the entire wiring structure, and it will not be effective in terms of calculation cost. Therefore, in this preferred embodiment, as shown on the right side of FIG. 6, the surface density of a dummy metal is calculated assuming that there are no wiring metals and dummy metals are distributed in a wiring layer with uniform density.

The surface density DD of a dummy metal in the dummy pattern as shown on the right side of FIG. 6 is calculated, and permittivity ∈_{c} after correction is calculated as follows, using the surface density DD and the actual permittivity ∈ before correction of a dielectric.

$${ɛ}_{c} = ɛ \times \frac{1}{1 - DD} = ɛ \times \frac{1}{1 - \frac{D1 \cdot D2}{( D1 + S1 ) ( D2 + S2 )}}$$

In this case, D1 and D2 are the horizontal and vertical lengths, respectively, of a dummy metal, and S1 and S2 are the horizontal space and vertical space, respectively, of the dummy metal. For example, if actual relative permittivity ∈ and the surface density of a dummy metal are 4.1 and 0.25, respectively, corrected relative permittivity becomes approximately 5.5.

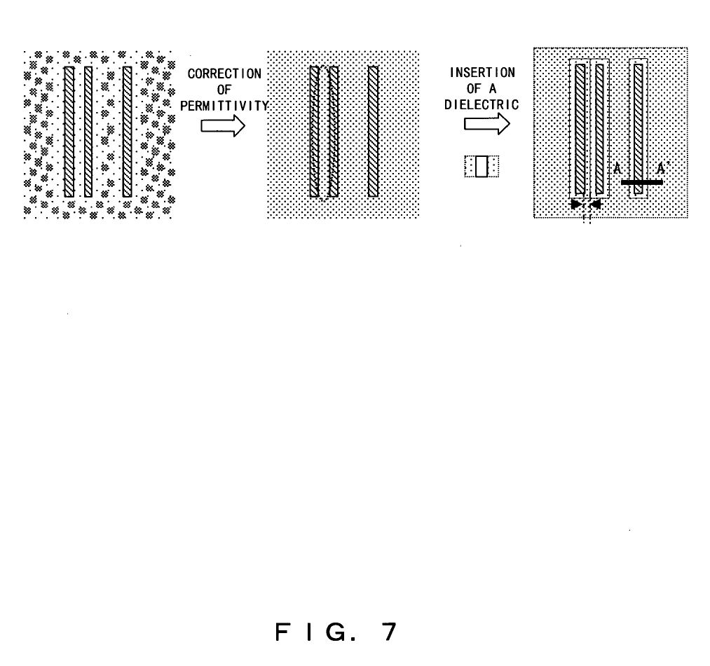

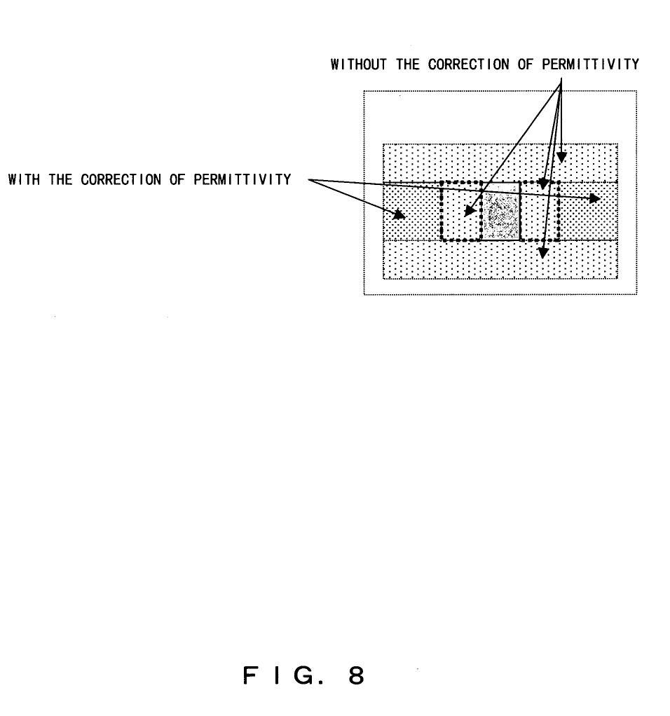

After the correction calculation of permittivity, permittivity before correction is applied to an area adjacent to a wiring metal, that is, a dielectric with its essential permittivity is inserted. This insertion is described below with reference to FIGS. 7 and 8.

In FIG. 7, as shown on its left side, although there are a wiring metal and a dummy metal in a wiring layer before the correction of permittivity, the dummy metal is not inserted close to the wiring metal.

In this state, if as described above, permittivity is corrected assuming that there are no wiring metals and dummy metals are distributed in a wiring layer with uniform density, as shown at the center of FIG. 7, a correction value is applied assuming that the permittivity of areas other than the wiring metal are all uniform. However, as described on the left side of FIG. 7, since the dummy metal is not inserted close to the wiring metal, capacitance becomes too large when correction is also applied to permittivity in its neighborhood area.

Therefore, as shown on the right side of FIG. 7, in the neighborhood of the wiring metal, a dielectric is inserted assuming that there is an actual dielectric with permittivity before correction. Thus, minimum space between the wiring metal and the dummy metal is calculated according to the dummy pattern generation rule, and an actual dielectric whose permittivity is not corrected is inserted in the neighborhood of the wiring located within a distance corresponding to this space. Thus, as shown on the left side of FIG. 7, static capacitance in a state where a dummy metal is not inserted in an area around the wiring metal can be calculated.

FIG. 8 shows the section A-A′ on the right side of FIG. 7. There are dielectrics whose permittivity is not corrected on both sides of the wiring metal at the center and there is a dielectric whose permittivity is corrected outside the area. Static capacitance is calculated assuming that there are no dummy metals on the top and bottom surfaces and instead there is a dielectric whose permittivity is not corrected.

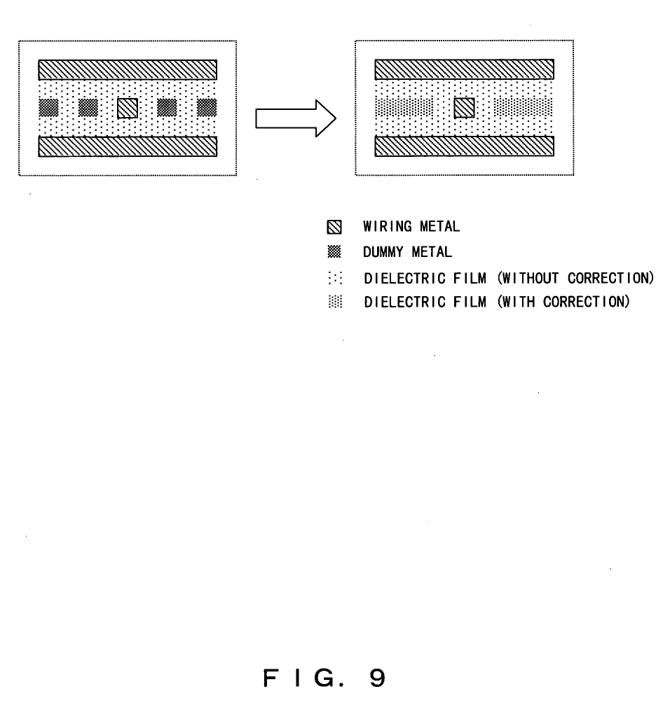

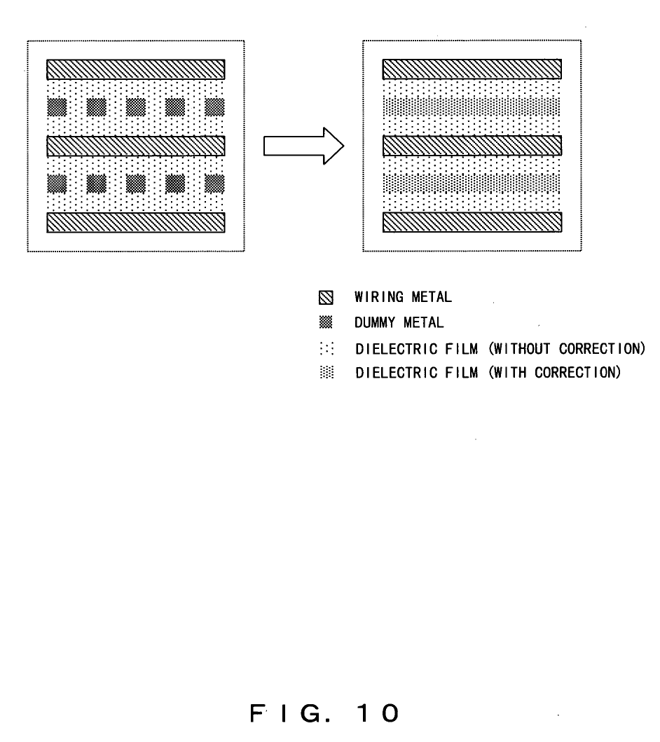

FIGS. 9 and 10 explain examples of permittivity correction in a multi-layer structure. In FIG. 9, a wiring metal and dummy metal are disposed in the center layer. However, as described in FIGS. 7 and 8, by applying permittivity correction to this center layer, permittivity is not corrected in the neighborhood of the wiring metal and instead permittivity is corrected on its both sides.

In FIG. 10, there are vertically five wiring layers, and there are only dummy metals in the second and fourth layers. In such a case, permittivity is corrected in the second and fourth layers, and static capacitance is calculated assuming that the second and fourth layers are the layers of dielectrics with corrected permittivity.

For example, in FIG. 5, static capacitance between, for example, a wiring metal at the center and a wiring metal on the right side is calculated theoretically assuming that space between wiring metals and the section area in the thickness direction of a wiring metal are d and S, respectively, and using equation ∈ S/d for static capacitance between parallel plates. Whether the static capacitance of a complex electric line of force distribution is further calculated depends on, for example, the contents of the RC extraction tool, and the calculation method of static capacitance has no direct relationship with the present invention. Therefore, its description is omitted here.

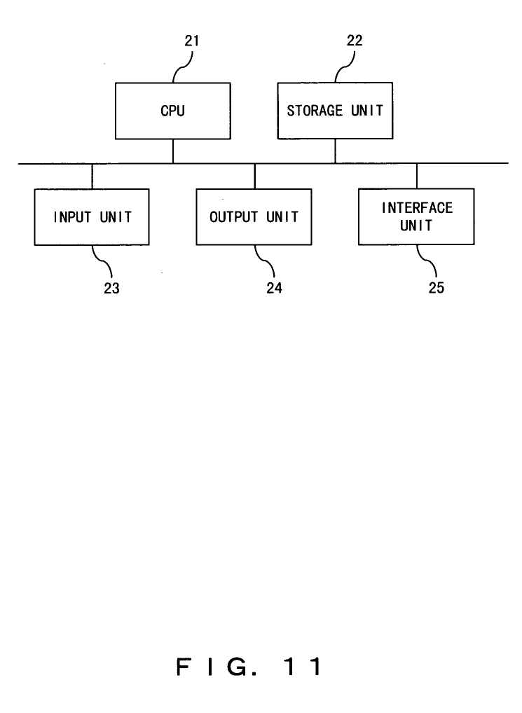

Next, FIG. 11 is described below. FIG. 11 shows the hardware configuration of the semiconductor circuit parasitic capacitance extraction device of the present invention.

In FIG. 11, a central processing unit (CPU) 21 controls each component by executing a control program.

For a storage unit 22, read-only memory (ROM), random-access memory (RAM) or a magnetic storage device is used. The storage device 22 stores the control program for controlling each component and is used as work area in the execution of the control program or a storage area of a variety if data.

An input 23 obtains a variety of data corresponding to the operation of a user.

An output unit 24 notifies a user of a variety of data by display it on a monitor or the like.

An interface unit 25 provides an interface function to transmit/receive data to/from other devices.

In order to implement the present invention using the device shown in FIG. 11, a program for enabling the CPU 21 to perform the processes shown in the flowcharts of FIGS. 3 and 4 must be generated and stored in the storage unit 22 in advance, and the CPU 21 must read and execute the program.

Since the configuration shown in FIG. 11 can be almost organized by a general computer, the present invention can also be implemented by such a computer. For that purpose, the control program for enabling a computer to perform the processes shown in the flowcharts of FIGS. 3 and 4 must be generated and stored in a computer-readable storage medium in advance, and must be read from the storage medium and be executed.

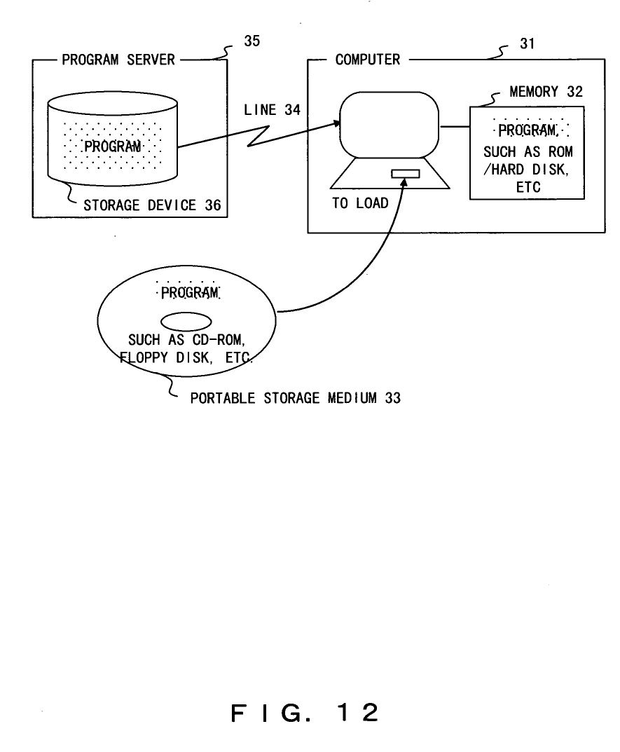

Examples of the computer-readable storage medium on which the control program are shown in FIG. 12.

As shown in FIG. 12, as the storage medium, memory 32, such as RAM or ROM provided as an auxiliary device which is built in or attached to a computer 31, a hard disk device or the like, or a portable storage medium 33, such as a flexible disk (FD), a magneto-optical disk (MO), a compact disk (CD-ROM a digital versatile disk (DVD)-ROM or the like can be used.

The storage medium can also be a storage device 36 with which a computer is provided, which functions as a program server 35 and which is connected to the computer 31 via a line 34. In this case, a transmission signal which can be obtained by modulating a carrier wave by a data signal representing the control program is transmitted from the program server 35 via the line 34, which is a transmission medium, and the computer 31 can execute the control program by demodulating the received transmission signal to reproduce the control program.

Besides, the present invention is not limited to the above-mentioned preferred embodiments and its variations and modifications are also possible.

What is claimed is:

1. A device for extracting parasitic capacitance including the influence of a dummy metal pattern inserted between the circuit wires of a semiconductor device, comprising:
a permittivity correction unit for correcting the permittivity of a dielectric existing between the circuit wires in accordance with the insertion of the dummy metal; and
a parasitic capacitance extraction unit for extracting parasitic capacitance between the circuit wires, based on the corrected permittivity and the layout of a circuit.

2. The device according to claim 1, wherein
said permittivity correction unit corrects permittivity by handling a dummy metal forming the dummy metal pattern as a dielectric with infinite permittivity.

3. The device according to claim 1, wherein
said permittivity correction unit corrects permittivity, using the surface density of an area between wires of a dummy metal forming the dummy metal pattern inserted between the circuit wires.

4. The device according to claim 1, wherein
said parasitic capacitance extraction unit extracts parasitic capacitance existing between the circuit wires by applying permittivity before the correction to a dielectric area adjacent to the circuit wires within a distance corresponding to a design minimum space between the circuit wires and the dummy metal pattern and applying permittivity after the correction to dielectric areas other than the adjacent dielectric area, based on the generation rules of a dummy medal pattern.

5. A method for extracting parasitic capacitance including the influence of a dummy metal pattern inserted between the circuit wires of a semiconductor device, comprising:
calculating the correction value of the permittivity of a dielectric existing between the circuit wires in accordance the insertion of the dummy metal pattern; and
extracting parasitic capacitance between the circuit wires, based on the correction value of permittivity and the layout of a circuit.

6. The method according to claim 5, wherein
the correction value of permittivity is calculated by handling a dummy metal forming the dummy metal pattern as a dielectric with infinite permittivity.

7. The method according to claim 5, wherein
the correction value of permittivity is calculated using the surface density of an area between wires of a dummy metal forming the dummy metal pattern inserted between the circuit wires.

8. The method according to claim 5, wherein
the parasitic capacitance existing between the circuit wires is calculated by applying permittivity before the correction to a dielectric area adjacent to the circuit wires within a distance corresponding to a design minimum space between the circuit wires and the dummy metal pattern and applying permittivity after the correction to dielectric areas other than the adjacent dielectric area, based on the generation rules of a dummy medal pattern.

9. A computer-readable storage medium on which is recorded a program for enabling a computer to extract parasitic capacitance including the influence of a dummy metal pattern inserted between the circuit wires of a semiconductor device, said program comprising:
calculating the correction value of the permittivity of a dielectric existing between the circuit wires in accordance the insertion of the dummy metal pattern; and
extracting parasitic capacitance between the circuit wires, based on the correction value of permittivity and the layout of a circuit.

10. The storage medium according to claim 9, wherein
the correction value of permittivity is calculated by handling a dummy metal forming the dummy metal pattern as a dielectric with infinite permittivity.

11. The storage medium according to claim 9, wherein
the correction value of permittivity is calculated using the surface density of an area between wires of a dummy metal forming the dummy metal pattern inserted between the circuit wires.

12. The storage medium according to claim 9, wherein
the parasitic capacitance existing between the circuit wires is calculated by applying permittivity before the correction to a dielectric area adjacent to the circuit wires within a distance corresponding to a design minimum space between the circuit wires and the dummy metal pattern and applying permittivity after the correction to dielectric areas other than the adjacent dielectric area, based on the generation rules of a dummy medal pattern.
